(19) United States
(12) Patent Application Publication
(10) Pub. No.: US 2005/0105247 A1
(43) Pub. Date: May 19, 2005

(54) Electric energy storage system

(76) Inventors: Hee-Young Lee, Seoul (KR); Ha-Young Lee, Gyeonggi-do (KR); Heui-Soo Kim, Seoul (KR)

Correspondence Address: CANTOR COLBURN, LLP, 55 GRIFFIN ROAD SOUTH, BLOOMFIELD, CT, 06002, US

(21) Appl. No.: 10/497,955

(22) PCT Filed: Feb. 28, 2002
(86) PCT No.: PCT/KR02/00340

(30) Foreign Application Priority Data
Dec. 7, 2001 (KR) 2001/77219
Feb. 23, 2002 (KR) 2002/9751

(51) Int. Cl. H01G 9/00

(52) U.S. Cl. 361/503

(57) ABSTRACT

An electric energy storage system having a novel structure which exhibits a ling cycle life, rapid charging-discharging characteristics and a high energy density. The electric energy storage system comprises: an anode comprised of a first material that performs interalation-deintercalation of cation as an anode active material; a cathode comprised of a second material that may form an electric doublelayer with anion as a cathode active materials; and a electrolyte including lithium salt, the electrolyte including the cation and anion. Due to a high difference between anode and cathode in capacity to store the electric energy, most electrochemical impact that occurs in the process of intercalation-deintercalation of electric energy is absorbed into cathode and active material used for anode is activated carbon having a very high resistance to electrochemical and structural impact, so that its operation life is elongated and it has rapid charging-discharging characteristics. The electric energy storage system can complement the defects of a conventional technology.

### TECHNICAL FIELD

The present invention relates to an electric energy storage system, and more particularly, to a novel electric energy storage system prepared by employing a transitional metallic oxide including lithium as an active material of an anode and an activated carbon as an active material of a cathode.

### BACKGROUND ART

Conventionally, as the representative conventional devices for storing electric energy, battery, capacitor, etc. may be mentioned. Specifically, a lithium rechargeable battery and an electrochemical capacitor are typical examples of the electric energy storage system. Since the lithium rechargeable battery has a high energy capacity, it is recently applied widely.

The lithium rechargeable battery is recently being used as an energy storage system attached to many portable electric equipments and has a high energy density, so that it began to occupy market share in market of the conventional rechargeable battery such as Ni—Cd rechargeable battery, Ni—H battery, alkaline battery, and the like. However, the lithium rechargeable battery can not be applied to an electric automobile, wherein the requirement rises suddenly, considering too short charging and discharging life time.

Recently, the lithium rechargeable battery has a charging-discharging life that reaches about 500 times. However, in order to apply the electric storage energy system to the electric automobile, the electric energy storage system should have a charging-discharging life reaching more than 100,000 times and has quick charging and discharging features. However, due to a driving principle, the electric energy storage system has a short cycle life and can not be promptly charged and discharged.

An electric energy storage system of the lithium rechargeable battery can not satisfy such technical requirement. The lithium rechargeable battery employs metallic oxide enabling electrochemical intercalation-deintercalation of lithium as the anode material and a graphite as the cathode material.

The process of intercalation-deintercalation of lithium from the cathode and the anode is an electrochemical reaction that is very slow and gives great impacts on the structure of the active material included in the cathode and the anode, so that the life of the battery is shortened. Moreover, it is known that a repeated rapid discharging-charging rapidly shortens the cycle life thereof.

Another representative electrochemical capacitor as one of electric energy storage system is an electric double layer capacitor (EDLC). EDLC employs an activated carbon having a large surface area as an active material for the cathode and the anode, and an electrolyte including an ammonium salt such as tetraammonium tetrafluoroborate, and tetraethylammonium hexafluorophosphate. These ammonium salts produce electric double layers onto the interface of the activated carbon having a large surface area. That is, the electric charge layers having polarity being different from each other are formed on the interface between the electrode and the electrolyte through an electrical static effect. The resultant electric charge distribution is called as an electric double layer. As a result, the surface area of the activated carbon has the same capacitance as a condenser.

Therefore, since the process producing the electric double layer is a rapid electrochemical reaction and does not give a structural impact on the active materials, the electric double layers show a long cycle life and rapid charging-discharging characters. However, the surface area of the activated carbon used for the active material can not be expanded infinitely and the capacity for storing an electric energy obtained from the electric double layer is very low as compared with an electrochemical oxidation-reduction reaction, so that it might be impossible to obtain a high energy density.

As compared with the above-mentioned rechargeable battery, an EDLC exhibits character being contrary to the rechargeable battery. Namely, the EDLC shows a rapid discharging and charging characteristic, a cycle life that is longer than a rechargeable battery, and is useful for a wide temperature range, as expected from the driving principle. However, the EDLC has a fatal weak point that the energy density is very low, as compared with a rechargeable battery.

Moreover, there is another electrochemical capacitor using a metallic oxide that shows similar characteristics to the EDLC. U.S. Pat. No. 5,600,535 (issued to Jow et al.) discloses an electrochemical capacitor that employs amorphous metallic oxide as an active material. Also, the above patent describes that if oxidized ruthenium is used, a high capacity of 430F/g can be obtained. However, this value means that the capacity is higher than a conventional EDLC but does not mean that capacity is higher than a lithium rechargeable battery. Also, a manufacturing cost of ruthenium dioxide is very high, so that ruthenium dioxide can not be actually employed for an active material of an electrode. Both the cathode and anode of electrochemical capacitor of a metallic oxide are composed of amorphous metallic oxide.

In the mean time, U.S. Pat. No. 6,252,762 (issued to Amatucci) discloses a hybrid battery/super capacitor system wherein charging-discharging may be performed. In the above system, the electrode that may perform interaction-deintercalation of ion is employed as the cathode and the one for capacity is as the anode. The above-mentioned patent discloses high energy density characteristics in a battery and rapid charging-discharging characteristics and a long life-time in a capacitor. However, even in the system having such a novel structure, much improved characteristics in the energy density, charging-discharging characteristics and loner life time are required.

The present inventors disclosed a system using both lithium salt and an ammonium salt as a solute of organic electrolyte entitled “Electrochemical Pseudocapacitor of Metallic Oxide Using An Organic Electrolyte” in Korean Patent Application No. 2000-71136, which was filed on 2000. Nov. 28. This application is a priority application of U.S. patent application Ser. No. 09/824,699. The above applications are pending in both countries. The above-mentioned applications disclose a technique for introducing two kinds of salts that are applicable to different systems into one system. Namely, the above applications disclose a system using a lithium salt applicable to a lithium rechargeable battery and an ammonium salt applicable to a capacitor such as EDLC simultaneously. The system exhibits satisfactory capacity characteristics.

According to the above-mentioned disclosure, when only one kind of salt is used, satisfactory results can not be obtained. When lithium ion is used only, an electric conductivity becomes low, so that the pseudocapacitor can not function as a capacitor. When an ammonium salt as a support electrolyte is added thereto, an electric conductivity becomes high so that desirable results can be obtained.

### DISCLOSURE OF INVENTION

In order to overcome the above problems in the conventional lithium rechargeable battery such as short cycle life and slow charging-discharging characteristics, and a low energy density that is one defect of an electrochemical capacitor, it is an object of the present invention to provide an electric energy storage system having a novel structure which exhibits a long cycle life, rapid charging-discharging characteristics and a high energy density.

To accomplish the above object, there is provided in the present invention an electric energy storage system comprising:
an anode comprised of a first material that performs interalation-deintercalation of cation as an anode active material;
a cathode comprised of a second material that may form an electric doublelayer with anion as a cathode active materials; and
an electrolyte including lithium salt and ammonium salt, the electrolyte including the cation and anion.

Preferably, the anode active material is an oxide including lithium and a transitional metal and the cathode active material includes an activated carbon.

The above object of the present invention may be accomplished by an electric energy storage system comprising:
an anode including a first material that performs interaction-deintercalation of cation as an anode active material;
a cathode including a second material that may form an electric double layer with anion as a cathode active material; and
an electrolyte including a lithium salt, the electrolyte including the cation and the anion.

Particularly, as the above-mentioned transitional metal, at least one selected from the group consisting of Ti, V, Cr, Mn, Fe, Co, Mo, and Ni may be preferably used. As an oxide including the lithium and the transitional metal, LiCoO2, LiMnO2, LiMn2O4, LiNiO2, LiMoO2, LiV2O5, LiCoxNi1-xO2(0<x<1), and the like may be mentioned.

The electrolyte may include a lithium salt such as LIBF4, LiAsF6, LiCIO4, LiPF4, etc. in a dissolved state, and simultaneously include an ammonium salt such as tetraethylammonium tetrafluoroborate ((CH3,CH2,)4,NBF6), tetraethylammonium hexafluorophosphate ((CH3,CH2,)4,NPF6), tetraethylammonium perclorate((CH3CH2,)4,NCIO4,) in dissolved state.

The present invention can overcome all the defects in the conventional electric energy storage systems such as a lithium rechargeable battery and EDLC by employing a transitional metal including lithium as an anode active material, activated carbon as a cathode active material, and an electrolyte including both lithium and ammonium salt or lithium only.

### BRIEF DESCRIPTION OF DRAWINGS

FIG. 1 illustrates a schematic structure of a winding type cell as one example of an electric energy storage system according to the present invention.

FIG. 2 illustrates a schematic structure of a packing type cell as one example of an electric energy storage system according to the present invention.

FIG. 3 is a graph illustrating changes in the electric potentials between a cathode and an anode when an electric potential is applied to the system, wherein as an anode, a transitional metallic oxide including lithium, LiCoO2 is used, as a cathode, BP of activated carbon is used, and as an electrolyte, an organic electrolyte prepared by dissolving LiPF6 of 1 M and (CH3CH2)NBF4 of 1 M in acetonitrile is used, as one example of an electric energy storage system according to the present invention.

FIG. 4 is a graph illustrating a result of the same system as in FIG. 3 measured by a volt scanning method.

FIG. 5 is a graph illustrating a result obtained when charging the same system as in FIG. 3 and then discharging the same system with 100 mA, 500 mA, 1 A and 3 A.

FIG. 6 is a graph illustrating a change in capacity during the same system as in FIG. 3 is discharged and charged 10,000 times at 1 V-2.3 V.

FIG. 7 is a graph illustrating changes in capacity according to frequencies of charging-discharging in a conventional lithium rechargeable battery and the system as shown in FIG. 3.

FIG. 8 is a graph illustrating changes in capacity according to frequency of charging-discharging in system (b) of comparative example 4 and the system as show in FIG. 3.

### BEST MODE FOR CARRYING OUT THE INVENTION

The present will be described in detail with reference to the attached drawings below.

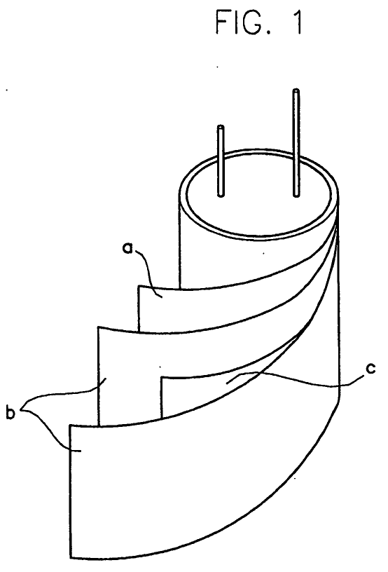

FIG. 1 illustrates a schematic structure of a winding type cell as one example of an electric energy storage system according to the present invention. In the figure, a denotes an anode, b denotes a separating insulation membrane and c denotes a cathode.

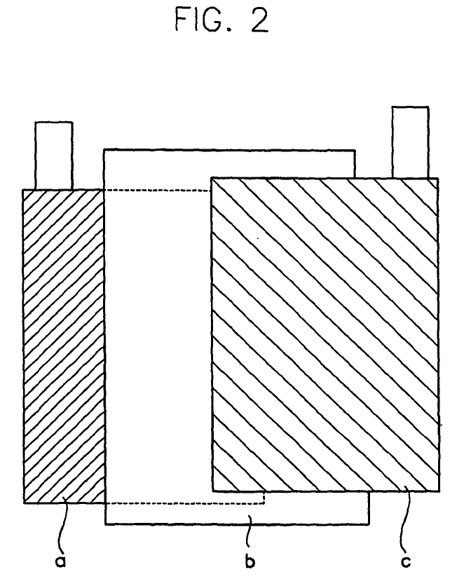

FIG. 2 illustrates a schematic structure of a packing type cell as one example of an electric energy storage system according to the present invention. In the figure, a denotes an anode, b denotes a separating insulation membrane and c denotes a cathode.

The driving method of the electric energy storage system according to the present invention is as follows:

In the anode, an electric charge and discharge occurs by oxidation-reduction reaction resulted from electrochemical intercalation-deintercalation of lithium ions included in an electrolyte and in the transitional metallic oxide including lithium. In the cathode, an electric charge is stored and discharged simultaneously with the anode by a fact that ammonium ion forms and removes an electric double layer on the surface of an activated carbon that is used as a cathode active material. Therefore, the electric energy storage system of the present invention exhibits a high energy density, a long life and rapid charging-discharging characteristics.

However, in case of the anode, the capability of storage-discharge of electric energy per unit weight is much higher than the cathode due to the difference in the driving principles.

For example, when a driving voltage is applied to an anode and a cathode having activated materials in the same quantity, the voltage of a cathode, whose capability to store energy is considerably lower than the anode, is changed rapidly, but the voltage of an anode is scarcely changed. Namely, the capability to store the electric energy of an anode is superior to the maximum value of the cathode. Also, the capability is used in a degree far less than the capability of an anode, so that a structural impact is lessened. Therefore, both long charging-discharging life and rapid charging-discharging characters are shown.

According to the present invention, a capability to store electric energy is expanded by using a high energy density of a transitional metallic oxide including lithium as an anode active material. Also, a long life cycle and rapid charging-discharging are shown by a fact that an activated carbon used for a cathode active material absorbs impacts applied to the active materials.

In the present invention, an electrolyte having a lithium salt only or both a lithium salt and ammonium ion is necessary. There is a big difference in efficiency between an electrolyte having both lithium salt and ammonium salt and an electrolyte having lithium or ammonium salt only. When an ammonium salt is used only, an initial capability to store electric energy is so low to correspond to approximately half of a case when mixed salts are used. Also, charging-discharging life is drastically dropped. This is because that the size of ammonium salt in the electrolyte is very large, so that the ammonium salt can not participate in electrochemical charging-discharging reaction and during the system is driven, the structure of an anode material is broken by an insertion reaction of the ammonium salt into an anode material by the voltage.

When only a lithium salt is used, the initial capability to store electric energy is somewhat dropped so as to reach approximately 90% as compared with a case of using a mixed electrolyte. However, this value is higher than using ammonium salt only. Therefore, using lithium salt only is also incorporated in the present invention.

A part of a transitional metal of an active material used for an anode of the system in the present invention can be replaced with Al, B, Ca, Sr, Si, etc., and the replaced quantity is preferably no more than 30% by mole. In case of a conventional lithium rechargeable battery, if a part is replaced with the above mentioned materials, a capability is enhanced by approximately 20% or less in view of cycle life. In order to confirm whether or not such enhancement of capability is shown in this system, the present inventors replace a part of the transitional material with the above materials when manufacturing active materials. The replacement may slightly enhance the capability, but such replacement may be also included in the present invention.

Likewise, oxygen in the anode active material can be partially replaced with S, I, F, Cl, Br, etc. It should be understood that all changes in the materials due to such replacement in a small quantity is included in the present invention.

The specific surface area of the anode active material is preferably no less than 200 m²/g. Generally, the capability to store energy by activated carbon is in proportional to the surface area of activated carbon, so that the wider the surface is, the more energy can be stored. Therefore, in case where the surface area of activated carbon is small, the capability to store energy is not high. The wider the surface area is, the more capability to store energy is enhanced. However, considering an economical efficiency, activated carbon having a specific surface area of about 500-2000 m²/g is preferably used.

When selecting electrode materials for an anode or cathode, an anode employs an electrode using a transitional metallic oxide including lithium as an anode active material and a cathode employs an electrode using activated carbon as a cathode active material. On the contrary, a system, wherein a cathode employing an electrode using a transitional metallic oxide including lithium as a cathode active material and an anode employing an electrode using activated carbon as an anode active material, is excluded. The reason is based on the electrochemical reaction mechanism generated from each electrode pole. The detailed explanation is as follows.

In the anode, charging means that voltage increases toward (+) direction. On the contrary, in the cathode, charging means that voltage increases toward (−) direction. At this time, cations having same polarity are forced towards a direction of far from anode by a repulsive force. These cations include not only cations of a salt dissolved in the electrolyte but also cations included in the anode active material. However, not all cations included in the active material can move freely. In only a specific case, cations can move. For example, in case of LiCoO2 comprised of two kinds of cations, Li and Co ions, Co ions forms a frame of the material, so that Co ions exist in a fixed state, but Li ions can freely come into and out of the frame formed by Co and O ions. Therefore, Li ions can move according to the polarity of voltage applied to the electrode.

In the anode, charging is a phenomenon that cation moves far from the anode and discharging is a phenomenon that cation moves toward the anode. If material such as LiCoO2 that may function to store an electric energy by intercalation-deintercalation of lithium ion is employed as an anode active material, Li ion is released during charging and Li ion is incorporated into the active material during discharging.

Since the reaction mechanism for storing an electric energy is as above-mentioned, the important items to be considered is a composition of material to be used as an active material. For example, LiCoO2 can be used as a cathode active material, but is not suitable for an anode active material. This is because a quantity of Li ion included in LiCoO2 is one mole and no more Li ions can be included therein. Namely, Li content in LiCoO2 is under a saturated state. Therefore, if LiCoO2 is employed as an anode and voltage of (+) pole is applied thereto during initial charging, Li ion can be released from the inside of the active material. On the contrary, if LiCoO2 is employed as a cathode and voltage of (−) pole is applied thereto during initial charging, Li ions can not be more incorporated into the active material.

If LiCoO2 is used as cathode and voltage of (−) pole is applied thereto, Li ions can not be moved into LiCoO2, so that the quantity of electric energy to be stored is pretty reduced and especially, an impact on the structure of the active material becomes big, so that the stability according to repeated charging-discharging operation decreases rapidly.

Activated carbon can be used for both electrode as an active materials of electric energy storage system regardless of the poles of electrodes. This is because it is different from an oxide including Li in electrochemical reaction system. In the oxide including Li, only Li ions can participate in process for storing electric energy. Namely, ions in the electrolyte wherein LiPF6 is dissolved are Li+ ion and PF6− ion. However, only Li ions participate in the reaction, thus the electric potential applied to the electrode acts as a very important factor.

However, the electrochemical reaction mechanism generated from activated carbon is a phenomenon of an electric double layer and both cation and anion ions can participate in this phenomenon, so that activated carbon can be applied to cathode or anode. Electric energy can be stored through forming an electric double layer by using anion or cation. During charging reaction of anode, (+) pole is applied, so that anion is used and during charging reaction of cathode, (−) pole is applied, so that cation is used. In this manner, the electric double layer is formed for storing an electric energy.

The electric energy storage system is manufactured as follows.

First, a conducting agent and a binder are added into a transitional metallic oxide including lithium such as LiCoO2, LiMnO2, LiMn2O4, LiNiO2, LiMoO2, LiV2O5, LiCoXNi1-XO2(0<x<1) and the like and then mixed. An anode is manufactured by coating the resultant on a surface of a thin metallic panel such as Al, Ni, Cu and the like. Preferably, the conducting agent and the binder in a predetermined amount are added to activated carbon, such as BP, MSC, MSP, YP (trade names; BP and YP are manufactured by Kuraray Co., Ltd. of Japan and MSC and MSP are manufactured by Kansai Cobes Co., Ltd. of Japan) having a specific surface area more than 200 m²/g and then mixed. A cathode is manufactured by coating the resultant on the surface of a thin metallic plate such as Al, Ni, Cu and the like.

An electrolyte wherein a lithium salt such as LiBF4, LiAsF6, LiClO4, LiPF6 and the like and an ammonium salt such as tetraethylammonium tetrafluoroborate, tetraethylammonium hexafluorophosphate, tetraethylammonium perchlorate and the like are dissolved in a ratio of 5:5 by mole is prepared. Particularly, a mixed ratio of the lithium salts with respect to the ammonium salt is about 4:6˜6:4. The electric energy storage system of the present invention is manufactured by inserting a separating insulation membrane including the above electrolyte between the two electrodes. When the electrolyte is prepared, adding an ammonium salt in addition to the lithium salt results in an enhanced capability to store the electric energy. This is because that the ammonium ion that is bigger than the lithium ion may enhance the effect on the formation of the electric double layer.

The preferred examples of the present invention will be described in more detail.

### EXAMPLE 1

As an anode active material, LiCoO₂ including lithium was used and as an cathode active material, BP (trade name manufactured by Kuraray Co. Ltd., Japan), a kind of activated carbon was used. After the active materials of each electrodes ware mixed with conductive carbon in a ratio of 8 to 2 by weight, water that includes a binder PVdF of 10 wt. % in a dissolved state was added thereto and then they were mixed, so as to prepare slurry. An aluminum foil having a thickness of 20 mm was coated with the resultant slurry, and then the coated aluminum foil was dried in a dryer at a temperature of 120° C., to complete an electrode.

Thus prepared electrodes were assembled together, by interposing a separating insulation membrane therebetween as shown in FIG. 1. The electrolyte was comprised of acetonitrile as a solvent and LiPF₆ of 1.0 M and tetraethylammonium tetrafluoroborate of 1.0 M as a solute. At this time, the surface area of each of the electrodes was 150 cm² and the assembled body of the electrodes and the separating insulation membrane was inserted into an aluminum cylinder having 10.2 cm³ in volume and then was sealed.

### EXPERIMENTAL EXAMPLE 1

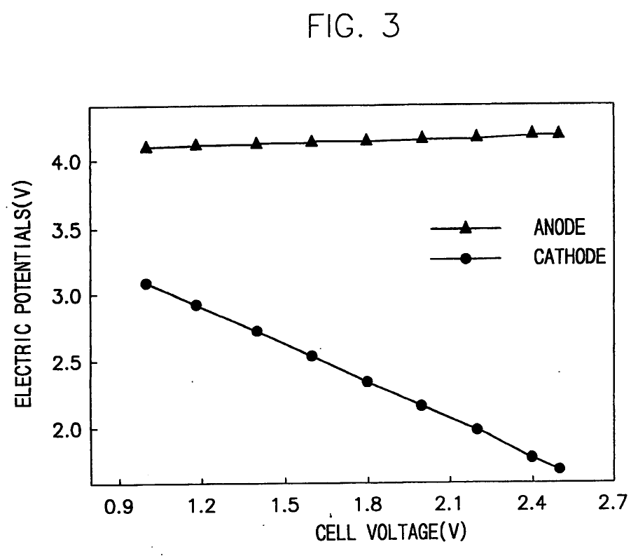

When voltage of 2.5V was applied to both anode and cathode of the electric energy storage system prepared in Example 1, the respective measured values of the voltage applied to anode and cathode are shown in FIG. 3.

During the electric potential is applied from 1V to 2.5V, the electric potential applied to the anode was actually changed from 4.1V to 4.8 V vs. Li/Li+ and the electric potential to cathode was changed from 3.08V to 1.69 V vs. Li/Li+.

As a result, changes in the electric potentials in the present system were almost observed on the cathode. Accordingly, it can be noted that an electrochemical impact when storing an electric energy has occurred on the cathode not the anode. This is the reason why a structurally fragile anode can be protected and the present electric energy storage system has a long life time and rapid charging and discharging characters.

### EXPERIMENTAL EXAMPLE 2

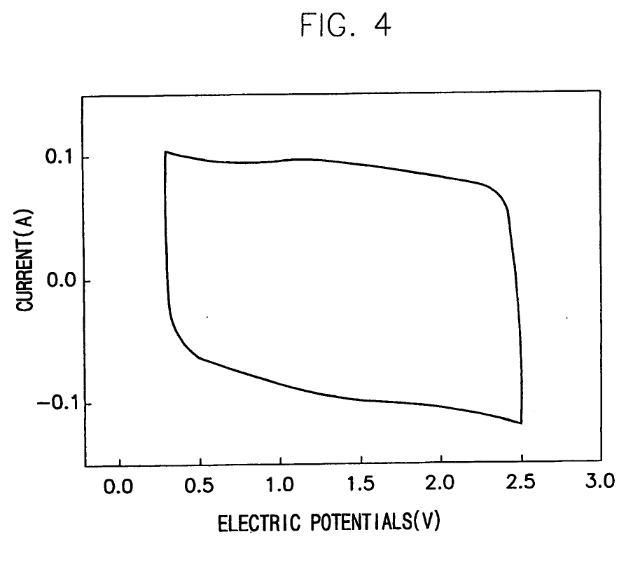

The measured CV value of the electric energy storage system prepared in Example 1 by a voltage scan method is shown in FIG. 4. As illustrated in FIG. 4, the measured value of CV is similar to that of an electrochemical capacitor.

### EXPERIMENTAL EXAMPLE 3

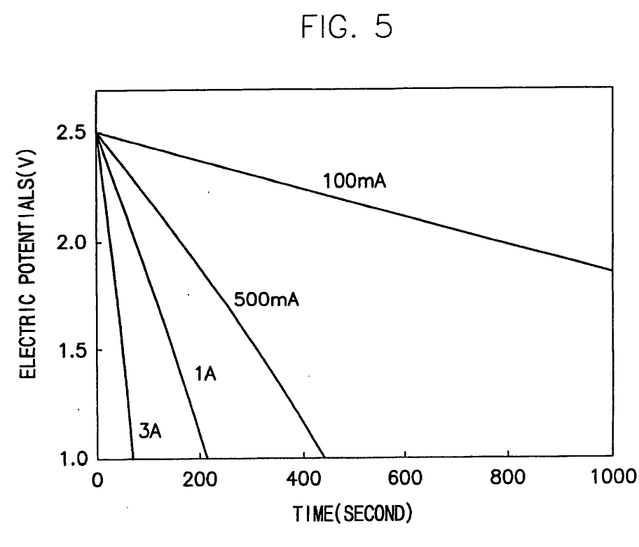

After the electric energy storage system prepared in Example 1 was discharged at 2.5V in the above electrolyte, the potential voltages shown during discharging at 100 mA, 500 mA, 1 A and 3 A were illustrated in FIG. 5. When calculated in a capacitance unit, the discharging capacitance reaches 139F that is high. Also, even at a high current of 3 A, the electric energy storage system can operate sufficiently.

### EXPERIMENTAL EXAMPLE 4

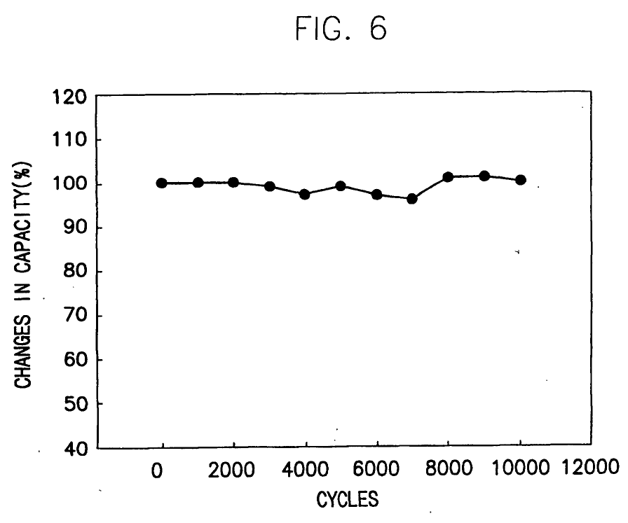

When an electric energy storage system prepared in Example 1 was charged and discharged continuously at 2.3-1.0 V with an electric current of 3 A in the above electrolyte, the changes in the capacities of the electric energy storage system are illustrated in FIG. 6. Although the charging-discharging time reaches 10,000, an excellent cycle life is shown, such that more than 80% of an initial capacity can be maintained.

### EXAMPLES 2-4

The same procedures were repeated as in Example 1, except that tetraethylammonium tetrafluoroborate of 1.0 M as a solute was unchanged and different kinds of lithium salts such as LiBF₄ (Example 2), LiCIO₄ (Example 3) and LiAsF₆ (Example 4) were used, thereby preparing an electric energy storage systems. Electric energy storage capacity when the systems were charged at 2.5V and then discharged at 0.1 A is shown in Table 1. As can be noted from Table 1, high capacities to store electric energy more than 130F were shown in all cases.

TABLE 1

| | Example | | |
|---|---|---|---|
| | Example 2 | Example 3 | Example 4 |
| Lithium salt | LiBF₄ | LiClO₄ | LiAsF₆ |
| Electric energy storage capacity | 138 | 128 | 132 |
| (F) | | | |

### EXAMPLES 5-7

The same procedures were repeated as in Example 1, except that LiPF₆ of 1.0 M as a solute was unchanged and different kinds of ammonium salts such as tetraethylammonium tetrafluoroborate (Example 5), tetraethylammonium hexafluorophosphate (Example 6) and tetraethylammonium perchlorate (Example 7) were used, so as to prepare an electric energy storage systems. Electric energy storage capacities when the systems were charged at 2.5V and then discharged at 0.1 A are shown in Table 2. As can be noted from Table 2, high capacities to store an electric energy more than 120F were shown in all cases.

TABLE 2

| | Example | | |
|---|---|---|---|
| | Example 5 | Example 6 | Example 7 |
| Ammonium | (CH₃CH₂)₄NBF₄ | (CH₃CH₂)₄NPF₆ | (CH₃CH₂)₄NclO₄ |
| salt | | | |
| Electric energy | 139 | 139 | 135 |
| storage | | | |
| capacity (F) | | | |

### EXAMPLES 8-12

The same procedures were repeated as in Example 1, except that LiMn2O4 (Example 8), LiMnO2 (Example 9), LiNiO2 (Example 10), LiCo0.8Ni0.2 O2 (Example 11), and LiA10.01Mn1.99O3.98S0.02 (Example 12) were used as an anode active materials, so as to prepare electric energy storage systems. Electric energy storage capacities when the systems were charged at 2.5V and then discharged at 0.1 A are shown in Table 3. As noted from Table 3, high capacities to store an electric energy were shown in all cases.

TABLE 3

| | Example | | | | |
|---|---|---|---|---|---|
| | | | Example | | |
| | Example 8 | Example 9 | 10 | Example 11 | Example 12 |
| Anode | LiMn₂O₄ | LiMnO₂ | LiNiO₂ | LiCo_{0.8}Ni_{0.2}O₂ | LiAl_{0.01}Mn_{1.99}O_{3.98}S_{0.02} |
| Material | | | | | |
| Electric | 135 | 132 | 127 | 136 | 133 |
| energy | | | | | |
| storage | | | | | |
| capacity | | | | | |
| (F) | | | | | |

### EXAMPLES 13-15

The same procedures were repeated as in Example 1, except that MSC (Kansai Cobes Co. Ltd., Japan, Example 13), MSP (Kansai Cobes Co. Ltd., Japan, Example 14), and YP(Kuraray Co., Ltd., Japan, Example 15), instead of BP as activated carbon were used as a cathode active material, so as to prepare electric energy storage systems. Electric energy storage capacities when the systems were charged at 2.5V and then discharged at 0.1 A are shown in Table 4. As noted from Table 4, high capacities to store an electric energy were shown in all cases.

TABLE 4

| | Example | | |
|---|---|---|---|
| | Example 13 | Example 14 | Example 15 |
| cathode material | MSC | MSP | YP |

### EXAMPLE 16

The same procedure was repeated as in Example 1, except that an electrolyte using LiPF6 of 1 M as a solute, instead of both LiPF6 and (CH3CH2)NBF4 of 1 M, was employed, so as to prepare an electric energy storage system. When the system was charged at 2.5V and then discharged at 0.1 A, an electric energy storage capacity is shown in Table 5. In a case where a lithium salt is used only, sufficiently a high capacity to store an electric energy was shown, although the value is somewhat lower than the case when using two kinds of salts simultaneously.

### COMPARATIVE EXAMPLE 1

The procedure was repeated as in Example 1, except that an electrolyte using tetraethylammonium tetrafluoroborate of 1 M only as solute, instead of both tetraethylammonium tetrafluoroborate and LiPF6 of 1M, was employed, so as to prepare an electric energy storage system. When the system was charged at 2.5V and then discharged at 0.1 A, an electric energy storage capacity is shown in Table 5. In a case where only an ammonium salt is used, a somewhat low capacity to store an electric energy was shown.

TABLE 5

| System | Example 16 | Comparative Example 1 |
|---|---|---|
| used salt | LiPF₆ | (CH₃CH₂)₄NBF₄ |
| Electric Energy storage | 125 | 86 |
| Capacity (F) | | |

### EXPERIMENTAL EXAMPLES 5-7

After charging-discharging the electric energy storage systems prepared according to Example 16, Comparative Example 1 and Example 1, the changes in capacities were observed. Each of the electric energy storage systems was continuously charged-discharged at 2.3-1.0V with an electric current of 3 A. After charging-discharging operations were performed 20,000 times, the observed changes in capacity are shown in Table 6. In case of an electric energy storage systems according to Example 16 and Comparative example 1 in which only one kind of salt was used, although there is a somewhat difference, after charging-discharging 20,000 times, 65-83% of the initial electric energy storage capacity reduced, so that they are expired. On the contrary, in case of an electric energy storage system according to Example 1, wherein an electrolyte is prepared by mixing two kinds of solutes, only 14% of the initial electric energy storage capacity was reduced under the same condition. Therefore, it can be noted that a case where lithium salt and ammonium salt are mixed together is superior to another case in performance.

As compared with cases using only one kind of a salt, in a case of using ammonium salt only or lithium salt only, respectively, 83% or 65% of the initial electric energy storage capacity was reduced. Therefore, if one kind of salt is used, a case of using lithium salt only is more superior to another case wherein one salt is used.

TABLE 6

| | Experimental Example | | |
|---|---|---|---|
| | Experimental | Experimental | Experimental |
| | Example 5 | Example 6 | Example 7 |
| Solute | LiPF₆ | (CH₃CH₂)₄NBF₄ | LiPF₆/(CH₃CH₂)NBF₄ |
| composition | | | |
| Reduction | −65 | −83 | −14 |
| ratio of | | | |
| electric | | | |
| energy | | | |
| storage | | | |
| capacity (%) | | | |

### COMPARATIVE EXAMPLE 2

In order to compare the energy storage system in accordance with the present invention with a conventional lithium rechargeable battery in cycle life, a lithium rechargeable battery was prepared by employing LiCoO2 and graphite as active materials of anode and cathode, respectively and LiPF6 as a solute of an electrolyte.

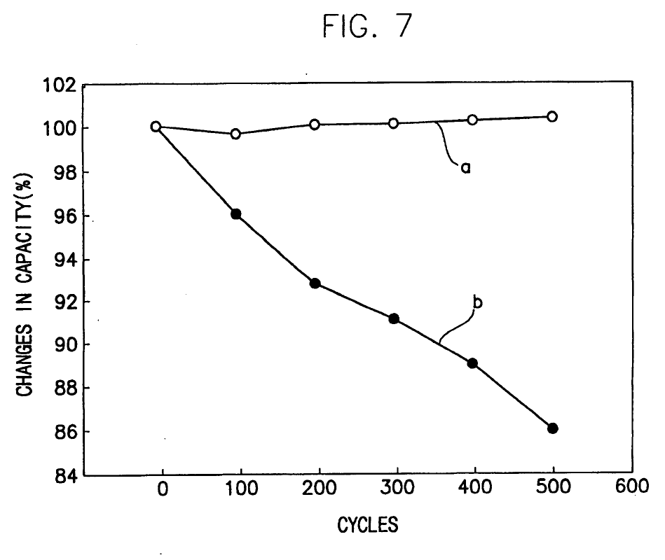

FIG. 7 is a graph illustrating changes in capacities according to cycle frequency with respect to thus obtained lithium rechargeable battery. Since a critical life of lithium rechargeable battery is about 500 cycle, the changes in capacities corresponding to low number of cycles were illustrated. In the figure, graph “a” illustrates changes in capacities corresponding to a low cycle frequency after the experiment was accomplished according to Experimental Example 4 with the present electric energy storage system manufactured in Example 1. Graph “b” illustrates changes in capacities corresponding to cycle frequency in the lithium rechargeable battery manufactured in Comparative Example 2.

However, since the driving condition of the present energy storage system is completely different from lithium rechargeable battery, the experimental conditions are somewhat different from each other. For example, while the voltage-driving boundary of the present invention was 2.5 V, that of lithium rechargeable battery was 4.2V. Therefore, although direct comparison under the exactly same condition is unreasonable, conditions suitable for an original driving purpose has been considered. Thus, it can be regarded as being comparable.

### COMPARATIVE EXAMPLE 3

In order to compare the energy storage system of the present invention with the capacity of a conventional EDLC, EDLC was prepared by using MSC as an active material and a solution wherein tetraammonium tetrafluoroborate of 1.0 M had been dissolved in acetonitrile. The same experiment as in Experimental Example 3 was repeated, except that the observation was obtained when it was discharged with 100 mA. When it is converted into capacity, it showed capacity to store an electric energy of approximately 47F. This value is very low one, as compared with the energy storage system manufactured in Example 1 and such comparison is shown in table 7.

TABLE 7

| | Comparative | Comparative |
|---|---|---|
| System | example 3 | example 1 |
| Electric energy storage capacity | 47 | 139 |
| (F) | | |

### COMPARATIVE EXAMPLE 4

As a cathode active material of cathode, LiCoO2 including lithium and as an anode active material, BP (Kuraray Co. Ltd., Japan), a kind of activated carbon was used. After active materials of each electrodes were mixed with conductive carbon in a ratio of 8 to 2 by weight, water including a binder PVDF of 10 wt. % in a dissolved state was added thereto and then the resultant was mixed, to obtain slurry. An aluminum foil having a thickness of 20 mm was coated with the resultant slurry, and then it is dried in dryer at temperature of 120° C., to complete electrodes.

Thus prepared electrodes were assembled together, by interposing an insulation membrane therebetween as shown in FIG. 1. The electrolyte was comprised of acetonitrile as a solvent and LiPF6 of 1.0 M and tetraethylammonium tetrafluoroborate of 1.0 M as a solute. At this time, the surface area of each electrode was 150 cm², and thus assembled body of electrodes and a separating insulation membrane was inserted into an aluminum cylinder having 10.2 cm³ in volume and then was sealed.

Electric energy storage systems prepared in Example 1 and Comparative Example 4 were charged at 2.3V and then discharged at a current of 0.1 A and then the resultant accumulated electric energy amount was observed. This result is shown in Table 8.

TABLE 8

| System | Example 1 | Comparative example 4 |
|---|---|---|
| Constitution of anode | LiCoO₂ (+)/ | Activated carbon (−)/ |
| and cathode | activated carbon (−) | LiCoO₂ (+) |
| Electric energy capacity | 139 | 47 |
| (F) | | |

As can be noted from Table 8, when an electrode using cobalt oxide including lithium as an active material was used as anode and an electrode using activated carbon as an active material was used as cathode, a very high electric energy storage capacity reaching 139F was shown. However, when wired conversely, namely, when an electrode using cobalt oxide including lithium as active material was used as cathode and an electrode using activated carbon as an active material was used as anode, a very low capacity of electric energy reaching 18F was shown. This value was very low so as to correspond to 13% thereof and is also low as compared to EDLC that uses activated carbon for both electrodes.

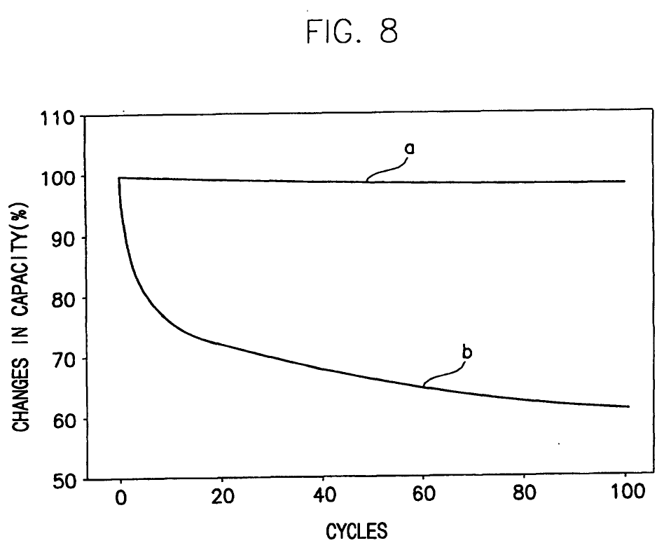

FIG. 8 is a graph illustrating comparatively changes in capacities due to charging-discharging frequency in the same system as in FIG. 3 prepared in Example 1 and the system according to Comparative Example 4. Namely, this shows changes in capacities when they were continuously charged and discharged at 2.3-1.0V with an electric current of 3 A.

As can be seen from graph “a” of FIG. 8, when anode employs an electrode using cobalt oxide including lithium as an anode active material and cathode employs electrode using activated carbon BP as a cathode active material, repeatedly charging-discharging 100 times does not affect capacities to store electric energy at all. As noted from graph “b” of FIG. 8, however, when wired reversely, namely, a cathode employs an electrode using cobalt oxide including lithium as a cathode active material and an anode employs an electrode using activated carbon BP as an anode active material, repeatedly charging-discharging 100 times results in loss of an electric energy of 40%.

Generally, considering that the frequency of repeated charging-discharging of the present electric energy storage system is at least 10,000 times, when wired reversely, namely, when the cathode employs an electrode using cobalt oxide including lithium as a cathode active material and the anode employs an electrode using activated carbon BP as an anode active material, it can be confirmed that a normal operation is hard to be expected.

When the anode employs a transitional metallic oxide including lithium and the cathode employs activated carbon and an electrolyte includes both lithium salt and ammonium salt, as in the present system, defects inherent in a lithium rechargeable battery and an EDLC, so-called conventional representative electric energy storage systems can be removed and following characteristics can be obtained.

Firstly, electric energy capacities which can be store an electric energy per unit volume or unit mass can be surprisingly enhanced by using high capacity to store an electric energy of a transitional metallic oxide including lithium used for anode.

Then, charging-discharging life characteristics being far superior to the conventional lithium rechargeable battery can be guaranteed. Due to a high difference between anode and cathode in capacity to store the electric energy, most electrochemical impact that occurs in the process of intercalation-deintercalation of electric energy is absorbed into cathode and active material used for anode is activated carbon having a very high resistance to electrochemical and structural impact, so that its operation life is elongated and it has rapid charging-discharging characteristic.

Finally, the present electric energy storage system, which can complement the defects of a conventional technology, is characterized in that it has much longer life time than the conventional lithium rechargeable battery; it has rapid charging-discharging features; and it has much higher capacity to store energy than the conventional electrochemical capacitor.

While the present invention is described in detail referring to the attached embodiments, various modifications, alternate constructions and equivalents may be employed without departing from the true spirit and scope of the present invention.

1. An electric energy storage system comprising:
an anode including a first material that performs interalation-deintercalation of cation as an anode active material;
a cathode including a second material that may form an electric double layer with anion as a cathode active material; and
an electrolyte including the cation and the anion, said electrolyte including both lithium salt and ammonium salt.

2. An electric energy storage system as claimed in claim 1, wherein said anode active material includes an oxide comprised of lithium and a transitional metal.

3. An electric energy storage system as claimed 2, wherein said transitional metal is at least one selected from the group consisting of Ti, V, Cr, Mn, Fe, Co, Mo and Ni.

4. An electric energy storage system as claimed 2, wherein said oxide is at least one selected from the group consisting of LiCoO2, LiMnO2, LiMn2O4, LiNiO2, LiMoO2, LiV2O5 and LiCoXNi1-XO2(0<x<1).

5. An electric energy storage system as claimed 1, wherein said cathode active material includes activated carbon.

6. An electric energy storage system as claimed 5, wherein a specific surface area of said activated carbon is no less than 200 m²/g.

7. An electric energy storage system as claimed 1, wherein said lithium salt is at least one selected from the group consisting of LiBF4, LiAsF6, LiClO4 and LiPF6.

8. An electric energy storage system as claimed 1, wherein said ammonium salt is at least one selected from the group consisting of tetraethylammonium tetrafluoroborate ((CH3CH2)4NBF6), tetraethylammonium hexafluorophosphate ((CH3CH2)4NPF6), and tetraethylammonium perclorate ((CH3CH2)4NCIO4).

9. An electric energy storage system comprising:
an anode including a first material that performs intercalation-deintercalation of cation as an anode active material;
a cathode including a second material that may form an electric double layer with anion as a cathode active material; and
an electrolyte including lithium salt, the electrolyte including the cation and anion.

10. An electric energy storage system as claimed in claim 9, wherein said anode active material includes an oxide comprised of lithium and a transitional metal.

11. An electric energy storage system as claimed 10, wherein said transitional metal is at least one selected from the group consisting of Ti, V, Cr, Mn, Fe, Co, Mo and Ni.

12. An electric energy storage system as claimed 10, wherein said oxide is at least one selected from the group consisting of LiCoO2, LiMnO2, LiMn2O4, LiNiO2, LiMoO2, LiV2O5 andLiCoXNi1-XO2(0<x<1).

13. An electric energy storage system as claimed 9, wherein said cathode active material includes activated carbon.

14. An electric energy storage system as claimed 9, wherein a specific surface area of said activated carbon is no less than 200 m²/g.

15. An electric energy storage system as claimed 9, wherein said lithium salt is at least one selected from the group consisting of LiBF4, LiAsF6, LiClO4 and LiPF6.

16. An electric energy storage system as claimed 9, wherein said ammonium salt is at least one selected from the group consisting of tetraethylammonium tetrafluoroborate, tetraethylammonium hexafluorophosphate and tetraethylammonium perchlorate.
